(19) United States
(12) Patent Application Publication
(10) Pub. No.: US 2009/0083179 A1
(43) Pub. Date: Mar. 26, 2009

(54) Web-accessible payment processing system

(76) Inventors: Jonathan Gustave, Spring Valley, NY (US); Gary Lazarus, Spring Valley, NY (US)

Correspondence Address: LEVISOHN, BERGER , LLP, 61 BROADWAY , 32ND FLOOR, NEW YORK, NY, 10022, US

(21) Appl. No.: 11/787,935

(22) Filed: Apr. 18, 2007

(51) Int. Cl. G06Q 20/00

(52) U.S. Cl. 705/40

(57) ABSTRACT

A streamlined automated system for processing payments which is web-accessible by clients through an interactive website. The interactive website allows for clients to directly access a database containing payment information and thereby resolve any exception that may have occurred in the course of processing a payment. The system is additionally configured to adaptively learn and apply information. The system furthermore integrated to allow the input of data at various remote locations and features a novel method of allocating data fields for efficient data entry.

### FIELD OF THE INVENTION

The present invention relates to the field of processing payments, specifically to an automated method of processing checks, money orders, wire transfers, credit card payments, periodic account debiting, electronic checks and similar payments along with associated account information.

### BACKGROUND OF THE INVENTION

Businesses, institutions or other similar entities routinely receive payments that may arrive in any variety of forms such as, but not limited to, checks, electronic checks, money orders, wire transfers and credit card payments. The processing of these payments is very expensive, involves human intervention and attention, and often results in errors, which must be resolved. For example, checks are routinely remitted for the payment of rental or leased property, mortgages, insurance policies and medical payments. In the most basic level, a paper check is conveyed to an obligee as a payment for a good or service. The payee receiving the payment then endorses the check and deposits it in a bank account. In some cases payees receive many checks on a monthly, weekly, or even daily basis. For each of the checks received, the accuracy of certain information must be verified for instance, whether the check is signed, written for the correct amount and associated with correct customer account information.

There are hundreds of thousands of offices that also regularly receive payments, such as doctors' offices, businesses, legal offices etc. The processing of such payments is largely manual and inefficient and delays crediting payments.

To minimize the transaction costs associated with remittance processing, many automated or semi-automated processes and devices have been designed for bulk processing of the same. Such lockbox processes reduce the unwieldy and time-consuming nature of processing bulk payments, while minimizing transaction costs and enhancing productivity. Remittance processing companies—which process inbound payments for clients such as businesses, institutions, banks and the like, who typically receive payments on a regular or irregular basis—commonly employ these lockbox processes.

Any automated or semi-automated system will invariably encounter exceptions i.e. discrepancies, inaccuracies, mistakes, or insufficient information whereby a payment cannot be properly processed without human intervention. For example, a check may be unsigned or missing its associated voucher, or a payment may have the wrong customer account information. These excepted payments or remittances are identified by the lockbox system and removed from the workflow until instructions from a client are received. In prior art models, the handling of exceptions requires processing facility personnel to communicate the problem or discrepancy to a client and wait for the client's instructions before manually updating and/or correcting the database. This requires a great deal of manual, human intervention which itself may result in an erroneous entry and introduces a time lag into the process, which ultimately leads to reduced efficiency and higher costs. It also is burdensome for a client who desires expeditious revenue recognition.

### SUMMARY OF THE INVENTION

In accordance with this invention, an automated system for handling bulk payments is described, which is capable of quickly and accurately processing large amounts of data, allows clients to immediately resolve exceptions by providing them with web-based access to a remittance processor's database and is capable of adaptively learning account histories. Features of this invention, either individually or in combination, provide for a streamlined and efficient process, which expedites the revenue recognition cycle.

In an embodiment of this invention, clients interface with the remittance processor's database through a secure website and directly and efficiently resolve exceptions. In this embodiment, exceptions are posted on a web page, which is configured to allow clients to hold, reject or otherwise modify information, whereby the processing company's database can be updated virtually in real time by the customer.

In another embodiment, the system further improves the resolution of exceptions by adaptively learning prior account histories and applying such information to subsequent transactions.

The inventive system also provides a platform for clients to customize their particular needs. In this embodiment, clients provide the processing company with specific parameters by which to identify exceptions.

It is an object of this invention to design a payment processing system that allows a client to directly resolve any exceptions.

Another object of this invention is to design a payment processing system that is capable of simultaneously applying a plurality of rules.

Still another object of this invention is to design a payment processing system that is capable of adaptively learning and unlearning prior account history.

Yet another object of this invention is to design a payment processing system that is capable of parsing the fields associated with a transaction and efficiently allocating said fields for processing.

Another object of this invention is to design a payment processing system wherein excepted transactions are easily searchable.

Yet another object of this invention is to enable payees to easily and efficiently access information on the system.

Still another object of this invention is to reduce the cost of handling transactions.

Other objects, advantages and features of this invention will become apparent from the following description.

### BRIEF DESCRIPTION OF THE DRAWINGS

FIG. 1 shows a block-diagram of a system configuration of an embodiment of the invention.

FIG. 2 shows a block-diagram representation of a database structure of an embodiment of the invention.

FIG. 3 shows a block-diagram of a web-based system for resolving exceptions.

### DETAILED DESCRIPTION OF THE INVENTION

Embodiments of the present invention will now be described with reference to the above-identified Drawings. However, the Drawings and the description herein of the invention are not intended to limit the scope of the invention. It will be understood that various modifications of the present description of the invention are possible without departing from the spirit of the invention. Also, features described herein may be omitted, additional features may be included, and/or features described herein may be combined in a manner different from the specific combinations recited herein, all without departing from the spirit of the invention.

An aspect of the present invention is directed to an improvement in remittance processing, specifically in identifying and resolving exceptions in a manner that is quick, efficient and cost-effective.

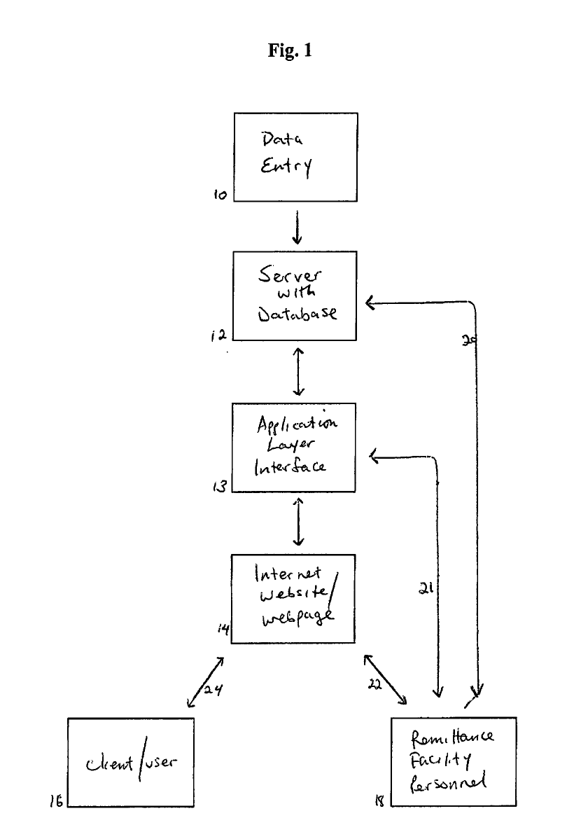

FIG. 1 shows a block-diagram of a system configuration of this invention wherein payment information—which includes banking information and any associated customer information—is entered through data entry into a database maintained on a server 12 of a processing facility. In a preferred embodiment, banking information includes, but is not limited to, credit/debit account information, electronic check numbers, and bank routing along with Direct Deposit Account (DDA) numbers. It will be understood by those skilled in the art that any of a variety of payment methods can be used in the remittance of a payment.

It is contemplated that data will be inputted 10 into the database 12 by any of several possible data entry methods. In one embodiment, checks, accompanying vouchers and/or other documents are scanned and automatically entered into the database. Alternatively, information can be manually keyed into the system or imported as an electronic file.

The processing company also maintains an interactive website 14 that is accessible by clients 16—at which that particular client's exceptions are displayed. There is a web-based interface 13 between the database and the website 14 whereby the processing facility can mediate information flowing to and from the website 14. Remittance facility personnel 18 may access the database 12 either directly 20 at the processing facility, remotely through authorized Internet access 22 or through the application layer interface 21.

The inventive remittance system comprises a computer system with software configured to identify exceptions based on set parameters. Parameters may be common to all clients or client specific. Exceptions may occur due to an error, discrepancy or insufficiency in any of various data fields. For example, an exception may result from a situation in which a customer remitted a lump sum to cover two payments. The system may identify this as an exception, for example, if one of the parameters, or rules were not to accept payments in excess of the amount due. In resolving such an exception, a client will instruct the processor how to allocate the funds remitted. In a preferred embodiment, a client will be given an option on the website to “split” the payment. Upon selecting “split,” preferably from a menu of options, the payment will automatically be allocated as more than a single payment. Alternatively, a client may have certain requirements, standards or restrictions in place for the acceptance and/or rejection of payments. For instance, a real estate management company may have a policy not to accept checks that are not for the full amount due. They might additionally, or alternatively, have a policy that the number of the apartment for which rent is remitted must be written in the memo line of a check. For the purposes of this document, all of these policies are called “rules.” When a rule is not followed, an “exception” to the rule occurs. In a preferred embodiment, the computer is adapted to automatically apply a plurality of rules to each remittance processed.

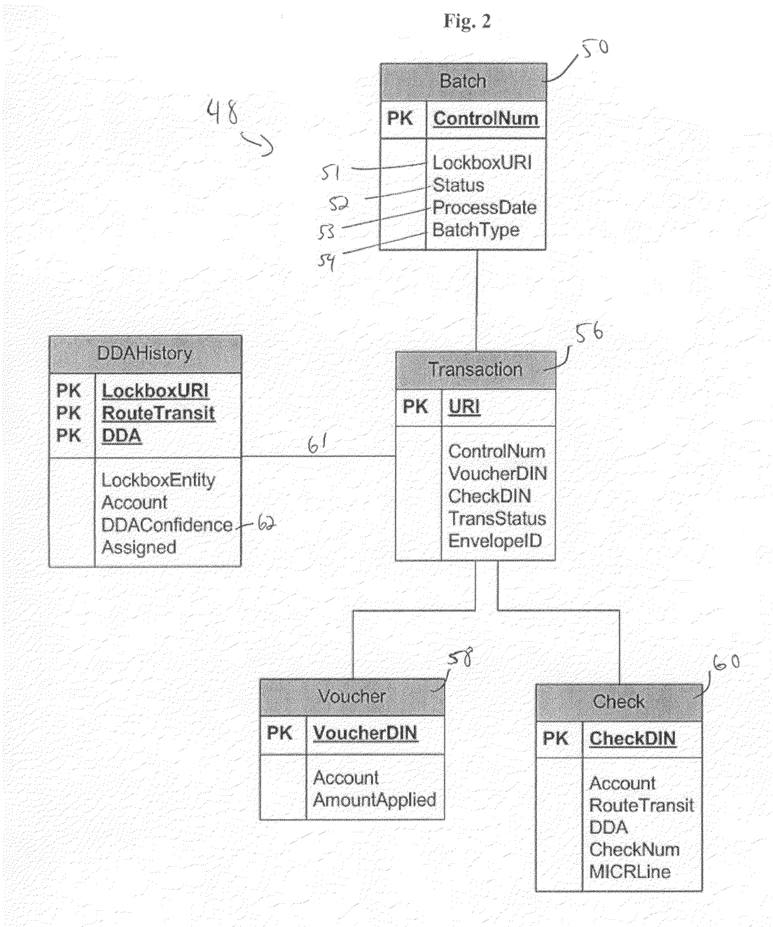

FIG. 2 shows a database structure 48 of a preferred embodiment of the invention. A batch 50 comprises multiple transactions 56. Each batch includes columns containing information unique to each transaction 56 such as, but not limited to, a lockboxURI 51 status 52 process date 53 and batch type 54. Transactions 56 are represented in a database 48 in a normalized form such that each component part is represented, including, but not limited to vouchers 58 and checks 60. A transaction 56 can comprise more than one of each, although not at the same time. This data representation allows the system to add or remove components according to client directive, enabling the addition of a voucher 58 alongside an existing one, or the effective “splitting” of a check 60. Batches 50 are collections of similar transactions and batch workflows are programmed as finite state machines. State transition tables control how batches advance through a workflow. Rules are used to modify, accept or reject individual transactions 56. Transactions 56 that are exceptions for the client can be modified in place, obviating the need to rescan. But, the batches 50 need to be reclassified to a new batch type 54 to avoid a rule again rejecting the transaction. In this manner, a client can direct that a transaction be accepted, overriding the automated rules. If an exception is handled prior to deadline, the transaction can be processed and deposited. But if it is not, the system automatically advances its process date to the next business day and the process resumes. Once it has been modified and accepted, the transaction is re-associated with the original scanned images for archival purposes. During the process, the system ensures that all applied amounts balance to the payment instrument (e.g. check, credit card, debit, etc.). All of this is done within a client's context as each web-based form is customized to use customer familiar terms and syntax.

When an exception is identified by the system, a linked secure webpage 14 is updated. Clients accessing the database 12 through the Internet 24 can retrieve information concerning any excepted items. In a preferred embodiment, a specialized application layer 13 that interfaces with the database 12 and the webpage 14 mediates clients' access to the database 12. This allows the remittance processor to screen information that is being posted from the database to the web page as well as incoming information supplied by clients. In a preferred embodiment, specific data fields on the webpage correspond to specific columns in the database 12. In one embodiment, a data field on the webpage 14 maps to a column in the database 12 by a one-to-one correspondence. In another embodiment, the correspondence is more than one-to-one.

The above configuration enables several advantages over prior art remittance processes. The application layer 13 between the database 12 and the Internet website 14 allows information as stored in the database 12 to be processed and/or modified before it is posted to the website 14. Information inputted by clients 16 through the website 14 can be similarly processed and or modified before the database 12 is updated or changed. This gives the remittance processor security and editorial control over information stored in its database while giving clients the latitude to quickly resolve exceptions.

The application layer interface 13 additionally allows the remittance processor to customize how information is displayed to certain clients. Because the link from database 12 to the webpage 14 is not direct, the application interface 13 can be configured to label various fields that are displayed on the web page differently from how they are labeled in the database. This allows the processor, in an embodiment of the invention, to communicate with clients using terms that are familiar to them. For example, if the database identifies clients by a “customer ID number” and a particular client refers to the same identifier as an “account number,” the software interface can be configured to translate “customer ID number” to “account number” when displaying account information to that particular client.

Additionally, because columns in the database need not map to fields on the webpage in a one-to-one basis, fields on the webpage may be parsed to receive information in a manner that is intuitive to a client and then combined by the software interface into one entry, consistent with the format of the database. For example, the database may store an address and apartment number as one entry—in the form of a string of numbers and/or letters. However, entries for an address and apartment number can map to two separate fields on a web page (e.g. one field for address and a separate field for apartment number) allowing a user to enter information in a simple and intuitive manner.

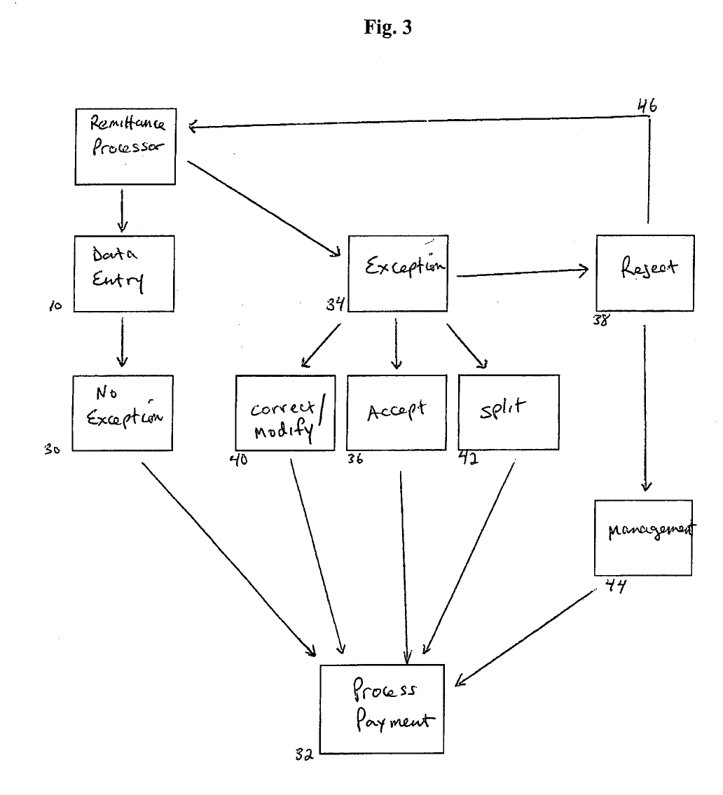

FIG. 3 shows a block-diagram of a system configuration of this invention wherein clients/users can directly resolve exceptions through an interactive website. After payment information is entered into the system through data entry 10, specialized software matches inputted data against set parameters. If there are no exceptions 30, the remittance is processed 32. If an exception is detected 34 it is immediately displayed on a secured webpage 12. Clients accessing the webpage will be able to view digital images of excepted remittance documents, and/or various excepted data fields. For example, if a customer entered an incorrect account number with a payment, a secure webpage 12 on the Internet might display all the fields that were entered in the course of processing that particular payment. However, the field that contained an error, in this example—the field for “account number” will contain an indication that an error was made. As an example, an excepted field may be highlighted in red, while non-excepted fields are highlighted in green or not highlighted at all. The client/user can at this point accept 36, reject 38 or modify information 40. If the client accepts 36, the payment continues to get processed as usual, whereas if the client rejects 38, the payment does not proceed. In a preferred embodiment, a client can reject in one of two ways: “reject to management” or “reject to remittance facility.” Preferably, a user selects a mode of rejection from a menu included on the website. If the nature of an exception is such that clarification, or further information is required from a customer, e.g. a landlord needs clarification from a tenant, he will select “except to management.” The exception will then be forwarded to management 44 or to a second party associated with a customer to be resolved—at which point it may proceed for processing. If the nature of the exception were such that a payment was made in error, a user would select “reject to remittance processor.” At that point the payment is forwarded back to the remittance processor 46 to be resolved.

In a preferred embodiment, clients can modify information that caused an exception. In a preferred embodiment, fields displayed on the webpage are linked through a web-based interface to corresponding columns in the processing facility's database. As such, a client has the ability to correct any of the given fields and thereby update the company's database virtually in real time. In this embodiment, instructions and/or information that is provided by a user through the website such as, for example, a correct account number or correct apartment number, is interpreted by an application in the interface layer, and entered into the database.

In addition to facilitating an immediate, accurate and inexpensive resolution of exceptions, the current invention presents a significant improvement over prior art batch processing. In prior systems, payment documents and checks are typically scanned in a first pass and, subsequently, checks are re-scanned in a second pass. If an exception is encountered, the client is contacted and must respond with instructions. However, once instructions are received the first pass must be run again, possibly without the original documents, which may have been destroyed. The current invention provides a truly automated processing system in which there is no need for a second first pass. Instead of repeating a transaction again with the correct information, as do prior art systems, the current invention allows a transaction to be placed on hold until correct information is obtained—at which point the transaction continues in its regular course.

In another embodiment of the current invention, the system can be programmed to analyze Direct Deposit Account (DDA) histories for a particular customer to identify a correlation between a DDA number and a customer account number. In this embodiment, when a customer remits a payment for a specific customer account using a particular routing and DDA number, the system will make an association between the DDA number and the customer account number for which it was used to pay. In subsequent transactions, the system can automatically credit a payment made using a particular DDA number to a particular customer account without the need for any further information. As such, in a check-only remittance, or in the absence of an accompanying voucher, a check can be processed based solely and entirely on a DDA number.

In a preferred embodiment, an analysis is conducted weekly to associate checking account information with client account information. This information can come from a number of different sources, including previous check-only work (i.e. a transaction wherein a check was not accompanied by a voucher) that was successfully processed or previous voucher and check work that was processed. Thresholding specific to the client is used to determine validity. For example, a threshold might be set at three unique associations between a DDA number and a customer account number. Then, filtering is used to separate the above-threshold items from those that need more inspection. In cases where no match is made, the item is referred to a data entry queue for keying and rekeying as necessary to ensure the accuracy of information entered. However, if a below-threshold match is found, it is directed only to rekeying and if there is a match against the set of possible values (i.e. against a below threshold DDA match) then it is considered likely to be correct. This approach significantly reduces the overall rate of keying errors. It also allows asynchronous keying of different parts of a transaction and supports a global data entry approach. The items are re-assembled after all keying partners return data and advanced as necessary. In addition to enhancing the efficiency of the system, this embodiment improves the accuracy of information entered.

In one embodiment, the system is configured to automatically credit a payment based on a DDA number only after a pattern has been established or a threshold number of associations has been met. For example, a threshold may be set at three distinct incidents of a particular DDA number being debited to pay a particular customer account. In another embodiment, the system is configured to “unlearn” DDA histories. In this embodiment, if after establishing a pattern of paying for a particular account, a DDA number is used to pay a different account, the system can be instructed to no longer process any future payments based on the DDA number alone.

In a preferred embodiment, automatic associations between DDA and customer account numbers are utilized only to ensure accuracy of information entered as a more efficient alternative to independent keyers.

In another embodiment, on the basis of instructions from a client, the system can be programmed to automatically always associate a DDA number to a particular customer account.

Referring to FIG. 2, when processing a transaction 56, the system will run a DDA history query 61 against the recent transaction history for the client based on a transaction's lockboxURI 51. Possible results of this query include the DDA confidence 62 (i.e. whether the DDA history above or below threshold) and whether or not the system has been instructed to automatically process the transaction 56 based solely on the DDA number.

In another embodiment of the current invention, the efficiency and speed of processing checks is further enhanced by a novel method of allocating the tasks of reading all relevant data fields associated with a check payment and entering them into corresponding columns in a database. In this embodiment, a check and associated documents, such as a voucher or pay stub, are scanned and stored as digital images. Preferably, a document scanner such as the Opex 3690 is programmed to automatically enter relevant data fields such the voucher number, or the scan line associated with a voucher, routing number and DDA number into corresponding columns in a database. A check's courtesy and legal numbers (CAR/LAR) (numerical and alphabetical descriptions of the check amount) often are handwritten, and as such a computer using specialized software adapted to accurately read handwriting is required for their automated interpretation. An image recognition engine such as A2iA's CAR/LAR recognition engine will accurately interpret most handwritten entries and can be programmed to automatically enter interpreted data into corresponding columns in a database. Handwritten entries that the CAR/LAR recognition engine interprets accurately are automatically entered into the database by the computer. However, out of a batch of checks, there will typically be a number of checks whose CAR/LAR information will not be interpreted accurately by the recognition engine. These checks thus require manual reading to correctly identify the dollar amount to be paid. Such human intervention necessarily translates into increased costs and system lag time before the checks can be fully processed.

An embodiment of this invention greatly minimizes such costs and lag time by parsing a check and allocating its various fields to where they can be interpreted most efficiently. In one embodiment, the machine printed portions of a check are read by a computer and entered into the database. However, digital images of the CAR/LAR fields, which are handwritten, are parsed and electronically sent to another location at which a system is set up for a trained staff of handwriting specialists who may quickly interpret the handwriting, key the data into a computer, save the data in a digital storage medium and send it back. Because only the CAR/LAR segment of checks is sent, no identifying information about the payor and/or payee is divulged. The interpreted dollar amounts are preferably sent back as a digital file, which automatically updates the database without further human intervention. Images can be sent as electronic files over the Internet or through an intranet connection. In an embodiment, the CAR/LAR images are tagged with an identifying code which corresponds to a code for the account that the CAR/LAR is associated with. The system is configured to match the code from an incoming CAR/LAR to its associated account. This system results in almost real-time processing of checks, even when the handwriting portion cannot be accurately read by a machine.

Batches are held in a suspended state during all external keying operations. Once all data have been returned completely, the batch is updated and advanced to the next state. This allows for an exponential increase in production since any number of data entry partners can be used simultaneously whereas previous systems were more linear in nature. It also allows for blind rekey of the same data for accuracy. Another advantage is for security and privacy since no one keyer will need to see an entire document or even an entire data field. This could be useful for keying HIPAA compliant information or Social Security numbers.

Numerous advantages are realized by scanning and storing digital images of payment documents. Digital images are indestructible, easily archivable and are easily replicated. In addition, the ability to parse and send only a snippet of a document, such as the CAR/LAR fields—as described herein above—presents a significant advantage over the prior art. In prior systems, all of the various fields associated with a check must be entered serially. Splitting a check into constituent fields, however allows for two or more fields to be entered into the system simultaneously.

A further advantage of this system is the ability to send the images overseas, or domestically, to a different time-zone. This is particularly advantageous when running checks at night, at which time handwriting specialists are not available locally.

In another embodiment, a challenge faced by any lockbox system—the efficiency of receiving payments from many remote locations and processing them in one central location—is largely minimized by an arrangement whereby scanners at various locations undergo an extensible stylesheet translation (xslt) to be compatible with the centralized processing system, creating a fully integrated global system for large-scale scanning and processing of payments. In this embodiment, a hub and spoke system is implemented in which enterprises at remote locations such as scanning facilities, vendors of goods or services, medical offices and institutions are outfitted with scanners that create files having format that are translated to be compatible with the central processor. Documents such as checks, vouchers, stubs containing credit/debit account information and the like can be scanned at these remote locations and sent as digital images to the central processor. Files that arrive at the central processor are read and inputted into the database in the same fashion as if the documents were scanned at the central processing facility as described earlier in this document. Original documents are not necessary and they must be destroyed within an appropriate timeframe. This arrangement allows the central processor to receive payments possibly within minutes of their being tendered, as well as negates the need to mail or deliver physical payment documents. This ensures both efficiency and speed while maintaining high accuracy in the processing of payments.

It will be understood by those of ordinary skill in the art that any organization, institution, charity or any entity that receives funds can benefit from the various embodiments of the inventive payment system disclosed herein. As an example, a university that receives donations of funds or a financial institution that receives payments or transfers of funds can benefit from the efficiency and time savings associated with the current invention.

A further embodiment of the present invention provides an interactive website, whereby a client can search prior and/or pending exceptions using multiple criteria and/or search terms. In this embodiment, the website provides fields wherein query information may be entered. For example, the website may contain a drop-down menu, from which a client may select to search by one or more search parameters such as, check amount, check number, account number, minimum or maximum payment amount, or any combination thereof.

In a preferred embodiment, the system can be configured to store search criteria. In this embodiment, a user can elect to initiate searches at various times without re-entering search criteria. A user can also schedule searches to run automatically at interval selected by the user.

Although the present invention has been described in accordance with the embodiments shown, one of ordinary skill in the art will recognize that there could be variations to the embodiments and those variations would be within the spirit and scope of the present invention. Therefore, although the present invention was described in terms of a particular remittance processing system, one of ordinary skill in the art readily recognizes that any number of parameters can be utilized and their use would be within the spirit and scope of the present invention.

What is claimed is:

1. A remittance processing system in which payments are made by a payor to be credited to a specified account and remitted to at least one payee, said payment processing system comprising:
a data base comprising payment information;
software capable of detecting exceptions in said payment information based on set parameters;
said database being web-accessible by users.

2. The system of claim 1, wherein said database is accessible through an interactive website.

3. The system of claim 2, wherein said interactive website displays exceptions.

4. The system of claim 2, wherein said interactive website displays digital images of payment documents.

5. The system of claim 2, wherein access to said database is mediated by software applications.

6. The system of claim 5, wherein said software screens information inputted into the website before entering said inputted information into the database.

7. The system of claim 5, wherein said software screens information outputted from the database to said website.

8. The system of claim 2, wherein information displayed on said interactive website can be modified by a user.

9. The system of claim 8, wherein modifying information on said interactive website correspondingly modifies information on said database.

10. The system of claim 2, wherein fields on said interactive map to columns in said database.

11. The system of claim 10, wherein said fields and said columns map in a one-to-one correspondence.

12. The system of claim 5, wherein said fields and said columns map in a more than one-to-one correspondence.

13. The system of claim 2, wherein a said interactive website provides a plurality of options for addressing exceptions.

14. The system of claim 10, wherein said options are selected from the group consisting of “accept” “reject” “split” and “modify.”

15. The system of claim 13, wherein said interactive website is configured to forward an exception to a second party, said second party being associated with said user.

16. The system of claim 13, wherein said interactive website is configured to allow a user to forward an exception back to the remittance facility.

17. The system of any of claims 15 or 16, wherein a user makes a selection on said interactive website to “reject to management” or “reject to remittance facility.”

18. The system of claim 14, wherein said interactive website is configured to split one payment into at least two payments when a user selects said “split” option on said interactive website.

19. The system of claim 1, wherein said payment information is automatically entered into said database by a computer.

20. The system of claim 1, wherein said payment information is manually keyed into said database.

21. The system of claim 1, wherein said payment information comprises digital images of scanned documents.

22. The system of claim 21, wherein said documents comprise bank checks.

23. The system of claim 21, wherein said documents comprise payment vouchers.

24. The system of claim 1, wherein said software further comprises at least one parameter, said software being configured to generate an exception if said at least one parameter is not satisfied.

25. The system of claim 24, wherein said at least one parameter is specified by a user.

26. The system of claim 25, wherein said at least one parameter is selected from a menu on a website.

27. A remittance processing system being capable of adaptively learning information, said system comprising:
a database comprising payment information, said payment information comprising at least a bank DDA number representing a bank account to be debited and customer account information identifying a customer account;
said system storing at least one instance wherein a bank DDA number is used for making a payment for an account identified by particular customer account information;
software configured to automatically associate a bank DDA number with particular customer account information based on a stored instance wherein said DDA number was used to make a payment for an account identified by said particular customer account information.

28. The system of claim 27, wherein based only on said DDA number, said system automatically credits a payment to an account identified by said particular customer account information from a bank account represented by said DDA number.

29. The system of claim 27, wherein said system stores a plurality of instances wherein a bank DDA number was used in making a payment for an account identified by particular customer account information.

30. The system of claim 29, wherein based only on said DDA number, said system automatically credits a payment to an account identified by said particular customer account information from a bank account represented by said DDA number.

31. The system of claim 28, wherein said system does not automatically credit a payment based only on a DDA number when said DDA number is used to pay more than one account.

32. The system of claim 31, wherein said system is configured to never credit a payment based only on a DDA number.

33. A remittance processing system in which payments are made by a payor to be credited to a specified account and remitted to at least one payee, said payment processing system comprising:
a scanner to scan checks;
a data base comprising at least a digital image of a check;
wherein a portion of said digital image, said portion comprising an image of at least one of a currency (CAR) and legal (LAR) field of a check is electronically sent out for remote processing.

34. The system of claim 33, wherein said image is sent via an intranet connection.

35. The system of claim 33, wherein said image is sent via the Internet.

36. The system of claim 33, wherein two separate images are sent, one image comprising an image of the currency (CAR) field and one image comprising the legal (LAR) field of a check.

37. The system of claim 33, wherein said remote processing comprises a means to read images of handwritten information contained in said CAR/LAR fields and enter said information into a computer.

38. The system of claim 33, wherein at least two check data fields are entered into a database substantially simultaneously.

39. The system of claim 37, wherein said information entered into said computer is stored on a digital storage medium.

40. The system of claim 37, wherein said information entered into said computer is returned in the form of an electronic file.

41. The system of claim 40, wherein said electronic file automatically updates a database comprising payment information.

42. A remittance processing system in which payments are made by a payor to be credited to a specified account and remitted to at least one payee, said payment processing system comprising:
a scanner at a first location to scan at least one payment document containing payment information and create a digital image of said payment document;
said scanner configured to electronically send said digital image to a second location in a format that is compatible with or is translatable to be compatible with a reader at said second location;
wherein specialized computers at said second location automatically enter payment information from said digital image into a database.

43. The system of claim 42, wherein said payment document comprises a bank check.

44. The system of claim 42, wherein said payment document comprises a check voucher.

45. The system of claim 42, wherein said payment document comprises a stub containing credit or debit card account information.

46. The system of claim 42, wherein said payment information comprises at least one of a bank routing number and a direct deposit account (DDA) number.

47. The system of claim 42, wherein said payment information comprises at least one of credit and debit card account information.

48. The system of claim 42, wherein said first location comprises a vendor of goods.

49. The system of claim 42, wherein said first location comprises a vendor of services.

50. The system of claim 42, wherein said second location comprises a remittance processing facility.
